(19) United States
(12) Patent Application Publication
(10) Pub. No.: US 2012/0269599 A1
(43) Pub. Date: Oct. 25, 2012

(54) THREADED STRUCTURES WITH SOLDER MANAGEMENT FEATURES

(76) Inventors: Shayan Malek, San Jose, CA (US); Richard Hung Minh Dinh, San Jose, CA (US); James W. Bilanski, Palo Alto, CA (US)

(21) Appl. No.: 13/188,418

(22) Filed: Jul. 21, 2011

Related U.S. Application Data
(60) Provisional application No. 61/477,452, filed on Apr. 20, 2011.

(51) Int. Cl. F16B 37/00; B21H 3/02

(52) U.S. Cl. 411/427; 470/11

(57) ABSTRACT

Threaded structures such as threaded standoff structures may be provided with features that control the flow of solder. A base structure for a standoff may be formed from a material such as metal. During attachment of the standoff to a substrate such as a printed circuit board, the base structure may be exposed to molten solder. A solderphilic coating may be provided on the outer surface of the standoff to encourage wicking of solder up and over lower portions of the standoff and beneath the standoff, thereby helping to secure the standoff to the substrate. The center of the base structure may be provided with threads to receive screws. To prevent solder from covering the threads, the surface of the threads may be provided with a solderphobic surface.

This application claims the benefit of provisional patent application No. 61/477,452, filed Apr. 20, 2011, which is hereby incorporated by reference herein in its entirety.

### BACKGROUND

This relates generally to mechanical structures, and, more particularly, to threaded structures such as threaded standoffs for use in assembling electronic devices.

Threaded structures such as threaded standoffs are often used in assembling electronic devices. For example, a threaded standoff may be used in attaching a component to a printed circuit board.

Standoffs are often attached to printed circuit boards using solder. If care is not taken, molten solder can wick onto portions of the threads in a standoff. This can make it difficult or impossible to insert a screw into the standoff.

It would therefore be desirable to be able to provide improved structures such as improved standoffs and other threaded structures that are exposed to solder.

### SUMMARY

Threaded structures such as threaded standoff structures may be provided with features that control the flow of solder. The features may include solderphobic and solderphilic surface regions.

A base structure for a standoff may be formed from a material such as metal. During attachment of the standoff to a substrate such as a printed circuit board, the base structure may be exposed to molten solder. A solderphilic coating may be provided on the outer surface of the standoff to encourage wicking of solder up and over lower portions of the standoff and beneath the standoff, thereby helping to secure the standoff to the substrate.

The center of the base structure may be provided with threads to receive screws. To prevent solder from covering the threads, the surface of the threads may be provided with a solderphobic surface. The solderphobic surface may be formed from an exposed portion of the base structure or a solderphobic coating.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view showing electronic device structures that may be assembled using threaded standoffs in accordance with an embodiment of the present invention.

FIG. 2 is a cross-sectional side view of a conventional standoff that has been exposed to molten solder during the process of mounting the standoff to a printed circuit board.

FIG. 3 is a cross-sectional side view of a standoff with solderphobic threads in accordance with an embodiment of the present invention.

FIG. 4 is a diagram of an illustrative deposition tool that may be used to coat a standoff in accordance with an embodiment of the present invention.

FIG. 5 is a diagram of an illustrative electroplating tool that may be used in coating a standoff in accordance with an embodiment of the present invention.

FIG. 6 is a diagram of an illustrative machining tool that may be used to drill openings, create threads in openings, and otherwise machine structures such as standoffs in accordance with an embodiment of the present invention.

FIG. 7 is a diagram showing illustrative steps involved in creating standoffs with solderphobic threads by machining threads into a structure with a solderphilic coating and a solderphobic base material in accordance with an embodiment of the present invention.

FIG. 8 is a diagram showing illustrative steps involved in creating standoffs with solderphobic threads by forming a masking layer over solderphobic threads during solderphilic coating operations accordance with an embodiment of the present invention.

FIG. 9 is a diagram showing illustrative steps involved in creating standoffs with solderphobic threads by forming a masking layer over a solderphilic coating during solderphobic coating operations accordance with an embodiment of the present invention.

### DETAILED DESCRIPTION

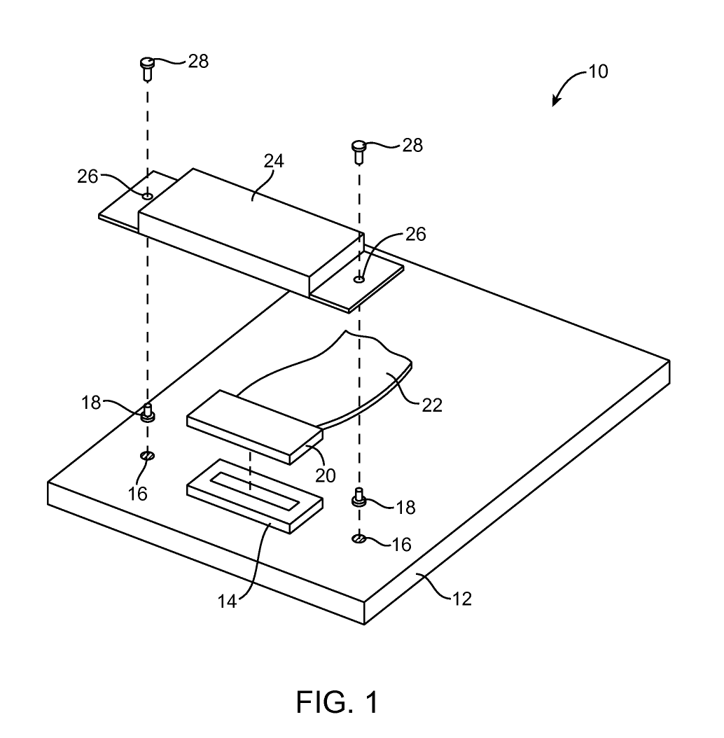

Structures such as metal fasteners and other structures are often used in assembling printed circuit boards, electronic components, connectors, and other structures associated with an electronic device. As shown in FIG. 1, for example, assembly 10 may include threaded structures such as standoffs 18. Standoffs 18 may be mounted to a substrate such as printed circuit board 12. Standoffs 18 may, for example, be soldered to solder pads 16 on the surface of printed circuit board 12.

Standoffs 18 may have threads that receive corresponding threaded screws such as screws 28. Standoffs 18 and screws 28 may be used to assemble structures such as shielding cans, cowlings, housing members, connector structures, and other electronic device structures. In the illustrative configuration shown in FIG. 1, screws 28 may pass through holes 26 in cowling 24 to mount cowling 24 on top of connector 20. Connector 20 may be, for example, a flex circuit connector that is connected to flex circuit 22. Connector 20 may mate with a mating connector such as connector 14 on printed circuit board 12. Once connectors 20 and 14 have been connected to one another, cowling 24 may be fastened over connectors 20 and 14 to help hold connectors 20 and 14 together.

Threaded structures such as standoffs 18 may be used in assembling any suitable structures. The example of FIG. 1 in which standoffs 18 are used in mounting cowling 24 over connectors 14 and 20 to secure the connectors is merely illustrative.

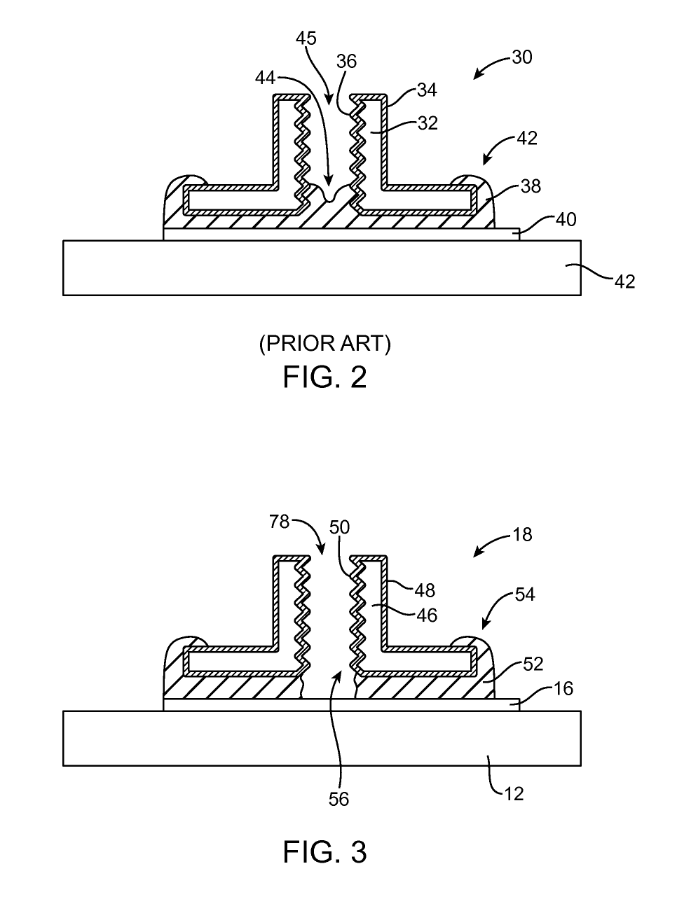

FIG. 2 is a cross-sectional side view of a conventional standoff mounted to a printed circuit board. As shown in FIG. 2, standoff 30 includes threaded opening 45 in brass body 32. Brass body 32 is coated with solderphilic coating 34. Coating 34 includes an inner nickel layer and an outer tin layer. When standoff 30 is mounted to metal pad 40 on printed circuit board 42, molten solder 38 is attracted to the tin in coating 34. This causes some of solder 38 to wick upwards in region 42 on the outer surface of standoff 30. The presence of the solderphilic tin layer on the surface of the threads in threaded opening 45 also tends to cause solder 38 to wick upwards and over some of the threads in opening 45, as shown by wicked solder portion 44 at the base of opening 45. The presence of solder portion 44 over the threads in standoff 30 can make it difficult or impossible to properly insert a screw into opening 45.

A standoff having a configuration that can help avoid coating threads with solder is shown in FIG. 3. As shown in the cross-sectional side view of FIG. 3, standoff 18 may be mounted on metal pad 16 on printed circuit board 12 using solder 52. To prevent solder from wicking over the threads in threaded opening 78, threaded opening 78 may be provided with a solderphobic surface (surface 50), whereas the remainder of standoff 18 (i.e., outer surface 48) may be configured to be solderphilic.

Surface 50 may be formed by exposing solderphobic brass from base structure 46 or by coating base structure 46 with a solderphobic coating. Surface 48 may be formed by forming base structure 46 from a solderphilic material (e.g., tin) and exposing this material or by coating base structure 46 with a solderphilic coating (e.g., a solderphilic coating formed from an inner layer of nickel and an outer layer of tin).

During soldering operations, solder portion 54 may wick up and over the solderphilic outer surface on the sides of standoff 18 and may wick along the solderphilic outer surface on the bottom of standoff 18, thereby helping to mount standoff 18 securely to printed circuit board 12. At the same time, solderphobic surface 50 may help prevent solder 52 from wicking onto threads in lower region 56 of opening 78. Because most or all of the threads in opening 78 remain solder free, screws such as screws 28 of FIG. 1 may be successfully inserted into opening 78.

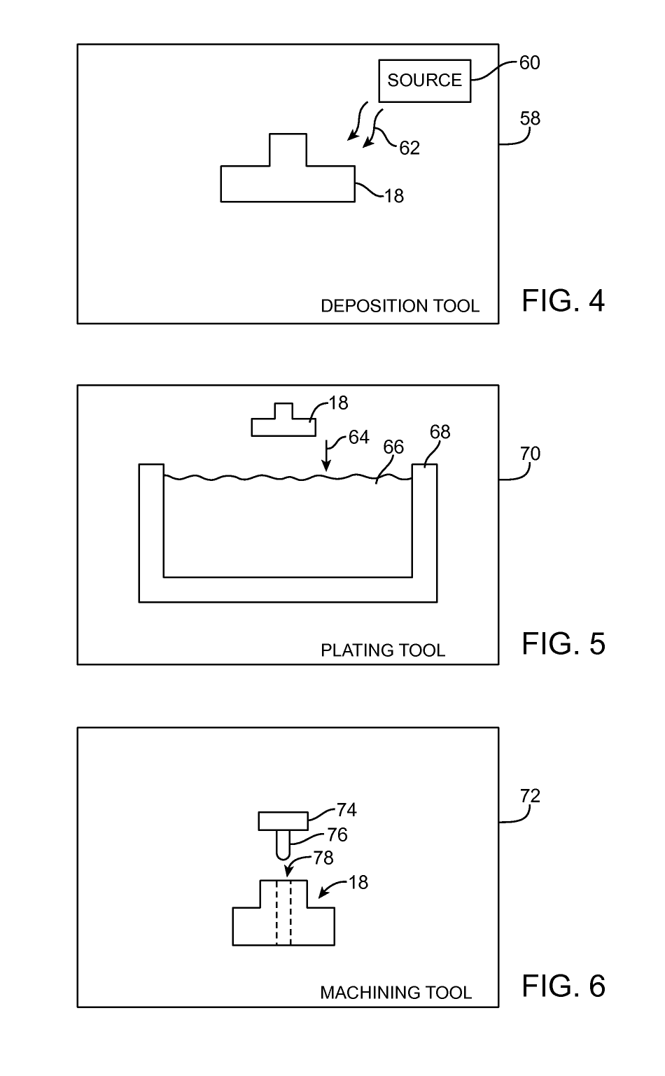

Any suitable manufacturing equipment may be used to form threaded structures such as threaded structure 18 of FIG. 3. As shown in FIG. 4, coatings such as solderphobic and solderphilic metal coatings may be deposited on the surfaces of standoff 18 using deposition tool 58. Deposition tool 58 may deposit coating materials 62 from source 60. Deposition tool 58 may use evaporation, sputtering, spraying, dipping, or other physical vapor deposition techniques. Deposition tool 58 may also use chemical vapor deposition techniques and other techniques for applying coatings to standoff 18.

As shown in FIG. 5, electrochemical deposition techniques may be used in coating standoff 18. For example, electroplating tool 70 may be used in coating standoff 18 with metal layers. During coating, standoff 18 may be lowered in direction 64 until some or all of standoff 18 is immersed in electroplating bath 66 in electroplating vessel 68.

FIG. 6 shows how standoff 18 may be machined using machining tool 72. Machining tool 72 may have drill bits, threading bits, and other bits such as bit 76. Motor 74 may rotate bits such as bit 76 to drill and thread openings such as opening 78 in standoff 18. Machining tool 72 may include stamping tools and other tools that form parts into desired shapes using pressure, laser cutting tools, plasma cutting tools, etc.

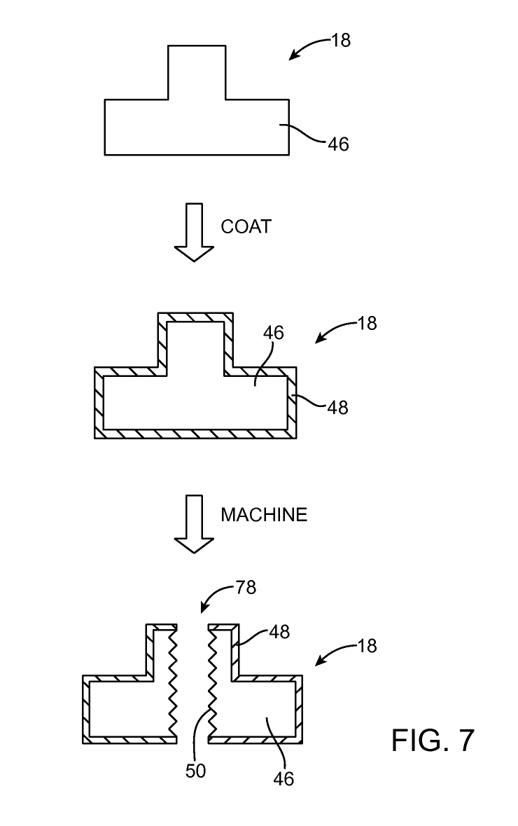

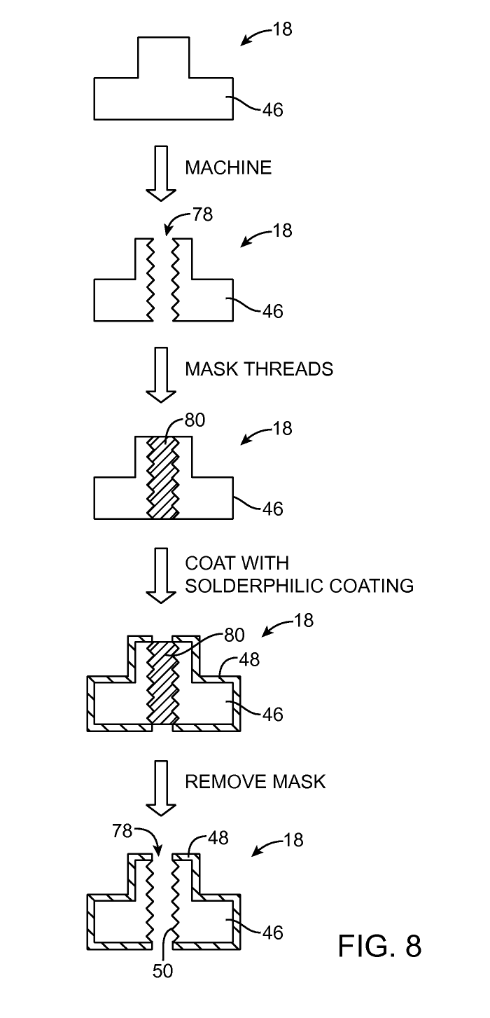

With one suitable arrangement, standoff 18 may be formed using an approach of the type shown in FIG. 7. Initially, standoff 18 may contain no threads, as shown by unthreaded standoff base portion 46 in the uppermost portion of FIG. 7. Base portion 46 may be formed from a solderphobic material such as brass or other solderphobic materials (e.g., solderphobic metals).

As shown in the center portion of FIG. 7, base portion 46 may be coated with a solderphilic coating such as coating 48 (e.g., an inner layer of nickel followed by an outer layer of tin or other suitable metals). Coating tools such as tools 58 and 70 may be used in forming solderphilic coating 48. Following coating with coating layer 48, threaded opening 78 may be formed in standoff 18 using machining tools such as tool 72 of FIG. 6. Because the machining process exposes the brass material that makes up base 46, the threads of threaded inner surface 50 of FIG. 7 will be solderphobic (i.e., the brass surface of the threads will tend to repel solder and resist solder wicking). The solderphilic coating on the outside of standoff 18 of FIG. 7 may encourage solder 52 to wick under the lower surface of standoff 18 and up and over the edges of standoff 18 (e.g., in region 54) to assist in forming a satisfactory bond with solder pad 16 on printed circuit board 12 during assembly.

If desired, an arrangement of the type used in FIG. 8 may be used to form standoff 18. With the FIG. 8 approach, base 46 may be formed from a solderphobic material such as brass or other solderphobic metals.

Initially, base 46 may be uncoated. The uncoated version of base 46 may be machined using machining tool 72 (FIG. 6). A masking material (e.g., a polymer, wax, etc.) such as mask material 80 may be formed over the threads in opening 78 (e.g., using deposition tool 58). Standoff 18 may then be coated with a solderphilic coating such as a coating formed from an inner layer of nickel and an outer layer of tin (e.g., using tools such as tools 58 and/or 70). Following removal of mask 80, inner surface 50 of threaded opening 78 will have a solderphobic surface (e.g., the exposed brass surface of base structure 46) and the remainder of standoff 18 will be covered with solderphilic coating 48.

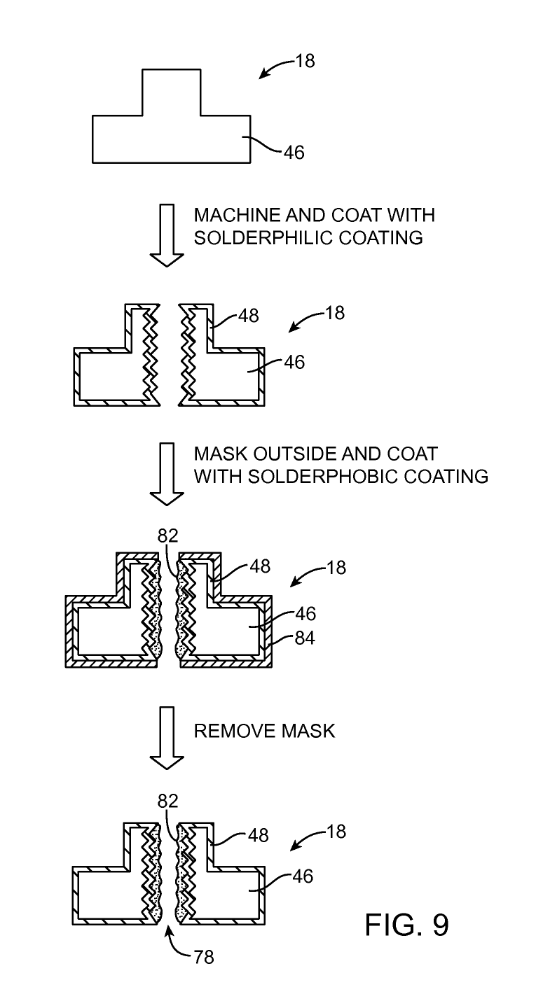

Another illustrative approach for forming standoff 18 is shown in FIG. 9. With the approach shown in FIG. 9, standoff 18 may initially be formed from a solderphobic material such as brass. Threaded opening 78 may be formed in base structure 46 using machining tool 72. Solderphilic coating 48 may be deposited over the machined version of base structure 46 using tools such as tools 58 and 70. Following formation of solderphilic coating 48, a masking layer (e.g., wax, polymer, etc.) such as masking layer 84 may be used to cover the portion of layer 48 on the outer surface of standoff 18. Masking layer 84 may be formed using tools such as tool 58 (as an example). After masking layer 84 has been deposited, solderphobic coating 82 may be deposited in threaded opening 78. As shown at the bottom of FIG. 9, masking layer 84 may then be removed, leaving solderphobic coating 82 in threaded opening 82 to protect the threads of standoff 18 from solder.

The foregoing is merely illustrative of the principles of this invention and various modifications can be made by those skilled in the art without departing from the scope and spirit of the invention.

What is claimed is:

1. A threaded standoff comprising:
a base structure having a solderphilic outer surface; and
a threaded opening in the base structure having a solderphobic surface.

2. The threaded standoff defined in claim 1, wherein the base structure comprises a solderphobic base structure and wherein the solderphilic outer surface is formed from a solderphilic coating on the solderphobic base structure.

3. The threaded standoff defined in claim 2, wherein the solderphobic base structure comprises brass and wherein the solderphilic coating comprises a material selected from the group consisting of: tin and nickel.

4. The threaded standoff defined in claim 1, wherein the base structure comprises a solderphilic base structure and wherein the solderphobic surface of the threaded opening is formed from a solderphobic coating on the solderphilic base structure.

5. The threaded standoff defined in claim 4, wherein the solderphilic base structure comprises a material selected from the group consisting of: tin and nickel.

6. A method of forming a threaded standoff comprising:
forming a solderphilic coating on an outer surface of a solderphobic base structure; and
forming a threaded opening in the solderphobic base structure to expose a solderphobic surface.

7. The method defined in claim 6, wherein forming the solderphilic coating on the outer surface of the solderphobic base structure comprises depositing the solderphilic coating on the outer surface of the solderphobic base structure using a deposition tool.

8. The method defined in claim 6, wherein forming the solderphilic coating on the outer surface of the solderphobic base structure comprises electroplating the solderphilic coating on the outer surface of the solderphobic base structure using an electroplating tool.

9. The method defined in claim 6, wherein forming the threaded opening in the solderphobic base structure comprises machining the threaded opening in the solderphobic base structure using a machining tool.

10. A method of forming a threaded standoff comprising:
forming a threaded opening in a base structure; and
forming masking material over at least part of the base structure.

11. The method defined in claim 10 wherein forming the masking material over the at least part of the base structure comprises forming the masking material over threads in the threaded opening.

12. The method defined in claim 11, further comprising:
forming a solderphilic coating on an outer surface of the base structure.

13. The method defined in claim 11, further comprising:
forming a solderphilic coating on an outer surface of the base structure; and
after forming the solderphilic coating on the outer surface of the base structure, removing the masking material from the threads in the threaded opening.

14. The method defined in claim 13, wherein the base structure comprises solderphobic material, and wherein forming the threaded opening in the base structure comprises machining the threaded opening in the solderphobic material.

15. The method defined in claim 10 further comprising:
forming a solderphilic coating on an outer surface and on the threaded opening of the base structure, wherein forming the masking material over the at least part of the base structure comprises forming the masking material on the outer surface of the base structure.

16. The method defined in claim 15, further comprising:
forming a solderphobic coating in the threaded opening of the base structure.

17. The method defined in claim 15, further comprising:
removing the masking material from the outer surface of the base structure.

18. The method defined in claim 15, wherein forming the masking material on the outer surface of the base structure comprises forming the masking material on the outer surface of the base structure after forming the solderphilic coating on the outer surface and on the threaded opening of the base structure.

19. The method defined in claim 18, further comprising:
forming a solderphobic coating in the threaded opening of the base structure; and
after forming the solderphobic coating in the threaded opening of the base structure, removing the masking material from the outer surface of the base structure.

20. The method defined in claim 10, wherein the base structure comprises a solderphobic base structure.
